(19) United States
(12) Patent Application Publication
(10) Pub. No.: US 2015/0113556 A1
(43) Pub. Date: Apr. 23, 2015

(54) CONTEXT-AWARE LOCATION-BASED INFORMATION DISTRIBUTION

(71) Applicants: John C. Weast, Portland, OR (US); Paul S. Diefenbaugh, Portland, OR (US); James R. Blakley, Portland, OR (US); Nithyananda S. Jeganathan, Portland, OR (US)

(72) Inventors: John C. Weast, Portland, OR (US); Paul S. Diefenbaugh, Portland, OR (US); James R. Blakley, Portland, OR (US); Nithyananda S. Jeganathan, Portland, OR (US)

(21) Appl. No.: 14/127,522

(22) PCT Filed: Oct. 17, 2013
(86) PCT No.: PCT/US2013/065464

§ 371 Date: Dec. 19, 2013

(51) Int. Cl. H04N 21/254; H04N 21/478

(52) U.S. Cl. CPC H04N 21/254; H04N 21/478
USPC 725/32

(57) ABSTRACT

Technologies are presented that provide location-based information distribution to targeted media devices. A method of distributing information by an information server in a networked media system may include determining a location of a first media device, determining one or more topics being consumed on the first media device, obtaining information categorically associated with one or more of the determined topics or the location of the first media device, and providing the obtained information to one or more of the first media device or a second media device in use within a predetermined proximity of the first media device. Determination of the location of the first media device may include determining whether the first media device is within a predetermined proximity of one or more other media devices with fixed known locations or of the information server. The provided information may include such information as advertisements, media recommendations, etc.

### BACKGROUND

Currently, targeted information presented to consumers through media devices is limited. to city, zip code, neighborhood, and individual home. No current system targets information presented to consumers through media devices in more granular locations. In addition, studies have shown that many media consumers using one media device (e.g., a television) may also use another media device (e.g., a smart phone or tablet) at the same time. No current system uses information derived from this type of scenario to deliver more accurate targeted information delivery to the consumer through the consumer's media devices.

### BRIEF DESCRIPTION OF THE DRAWINGS/FIGURES

FIG. 1 is a block diagram of an example system described herein, according to an embodiment.

FIG. 2 is a block diagram of an example information server of FIG. 1, according to an embodiment.

FIGS. 3 and 4 are flow charts illustrating example process flows, as described herein, according to embodiments.

FIG. 5A is a block diagram illustrating, an example room setup of a home, according to an embodiment.

FIG. 5B is a block diagram illustrating media consumption examples of each device in various rooms of a home, according to an embodiment.

FIG. 6 is a block diagram of an example information server, according to an embodiment.

FIG. 7 is a block diagram of an example media device, according to an embodiment.

In the drawings, the leftmost digit(s) of a reference number may identify the drawing in which the reference number first appears.

### DETAILED DESCRIPTION

Disclosed herein are technologies that solve the technical problem of providing more accurate targeted information to users of media devices in the context of the usage (e.g., locations, activities, etc) of those media devices. With the technologies disclosed herein, the described system may allow for the delivery of targeted information (such as advertisements, media recommendations, etc.) to one or more media devices of a user in one or more context(s) including what media device(s) are being used, what the user is doing with the media device(s), when the user is doing it, where the user is, who the user is, etc.

Embodiments are now described with reference to the figures, where like reference numbers may indicate identical or functionally similar elements. While specific configurations and arrangements are discussed, it should be understood that this is done for illustrative purposes only. A person of ordinary skill in the relevant art will recognize that other configurations and arrangements can be used without departing from the spirit and scope of the description. It will be apparent to a person of ordinary skill in the relevant art that this may also be employed in a variety of other systems and applications other than what is described herein.

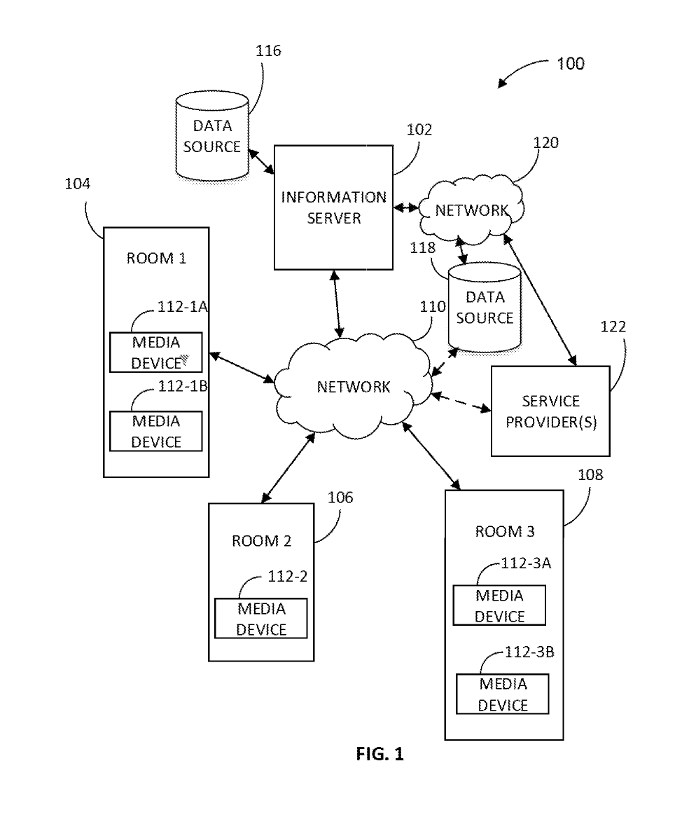

FIG. 1 is a block diagram of an example system 100, according to an embodiment. System 100 may include an information server 102 that may be in communication with various media devices 112 that may be used in various areas or rooms (e.g., rooms 104, 106, 108) of a building or establishment via a network 110. As shown in FIG. 1, there may be more than one media device 112 present in an area or room. Information server 102 may include, or may have direct access to, a data store or data source 116, or may have access to an external data source 118 that is communicatively connected to information server 102 via network 110 and/or a separate network 120 (as shown in FIG. 1). Various types of media may be provided to system 100 by one or more media service providers 122 (cable television providers, music service providers, internet game providers, video providers, websites, communication service providers, etc.) via network 110 and/or network 120. Various elements of system 100 will be described in more detail below.

Rooms 1, 2, and 3 (104/106/108) may represent areas or rooms of a building or establishment, such as, for example, but not to be limited to, a home, a hotel, a dormitory, an office building, a school campus (e.g., a college campus), an office complex, an amusement park area or ride, a park or recreational area, etc. For ease of discussion herein, rooms 1, 2, and 3 (104/106/108) represent rooms of a home. However, one of ordinary skill in the art would appreciate that the concepts described herein may extend to other types of buildings or establishments.

Media devices 112 may be used by users to consume various types of media (e.g., television programs, videos, music, games, websites, communications (email, messaging, texting, etc.), etc.). Media devices 112 may be personal computing devices that may include mobile and non-mobile devices. Mobile devices may include, but are not to be limited to, for example, laptop computers, ultra-laptop computers, tablets, touch pads, portable computers, handheld computers, palmtop computers, personal digital assistants (PDAs), e-readers, cellular telephones, combination cellular telephone/PDAs, mobile smart devices (e.g., smart phones, smart tablets, etc.), mobile internet devices (MIDs), mobile messaging devices, mobile data communication devices, mobile media playing devices, cameras, mobile gaming consoles, etc. Non-mobile devices may include, but are not to be limited to, for example, personal computers (PCs), televisions, smart televisions, data communication devices, media playing devices, gaming consoles, monitors, wall panels, etc. Media devices 112 may include tuners with speakers that may or may not also include a visual display. Media devices 112 may include set-top boxes (e.g., cable set-top box, digital video recorders (DVRs), gaming consoles, etc.) that may be connected to, and configured to control the presentation of media on, a display or presentation device such as a television, a monitor, a wall panel, personal computer, media. playing device, etc.

Media devices 112 may include controllers and other components that execute software and/or control hardware in order to execute local programs or consume services provided by external service providers over a network. For example, media devices 112 may include one or more software clients or applications for utilizing or accessing web-based services, games, videos, music, etc., as well as cable-based services such as cable television, on-demand videos, etc. Media devices 112 may also, or instead, include a web interface running in a browser from which the media device can access such services. Media devices 112 may include storage devices (not shown in FIG. 1) to store logic and data associated with the programs and services used by the media devices 112. Media devices 112 may include location-aware capabilities or devices, such as global positioning system (GPS) devices or devices with similar capabilities. For network communication, media devices 112 may include components that facilitate communication through wired or wireless technologies such as cable, Ethernet, Wi-Fi, Bluetooth®, etc.

Network 110 may be any wired or wireless network, such as a Wide Area Network (WAN), a Local Area Network (LAN), and/or the like. In an embodiment, network 110 may be a home network or LAN. In another embodiment, network 110 may be a distributed public network, such as the Internet. In either embodiment, information server 102, media devices 112, and media service providers 122 may be connected to the network 110 via wired or wireless connections. In an embodiment where network 110 is a distributed public network, network 120 may not be needed, and data source 118 may be accessible via network 110.

Network 120 may be any wired or wireless network, such as a Wide Area Network (WAN), a Local Area Network (LAN), and/or the like. In an embodiment Where network 110 may be a home LAN, network 120 may be a distributed public network, such as the Internet. In another embodiment, networks 110 and 120 may represent a single network (e.g., the same network).

Data source 116 may be a part of information server 102, or may be external to information server 102. The data stored at data source 116 may include, for example, information that may be provided to one or more various media devices by information server 102, category associations and/or alternatives for the information, location information regarding the one or more various media devices, etc.

Information server 102 may be implemented in software and/or hardware executed or controlled by a controller of information server 102. While only one information server is illustrated for clarity and ease of discussion, it should be appreciated that information server 102 may include multiple distributed server computers for redundancy, task sharing, and/or load sharing, for example, which may be useful for embodiments that include many networked media devices. In an embodiment, information server 102 may be owned and/or maintained by a media service provider. In another embodiment, information server 102 may be owned and/or maintained by a manager (or designated administrator) of the home or establishment. In an embodiment where the system is within a home, the manager or administrator may be the homeowner, for example. With regard to location of information server 102, in an embodiment, information server 102 may be located within a home or establishment. In another embodiment, information server 102 may be located external to the home or establishment (e.g., at a location of a service provider 122 (such as at a cable television headend)). In yet another embodiment, a portion of information server 102 may be located within the home or establishment, while another portion of information server 102 may be located external to the home or establishment (e.g., at a location of a service provider 122).

With today's technology, both video and data types of media may be provided to a single device, and delivered to various endpoints in a building or establishment (e.g., in an interne protocol (IP) based environment). In embodiments, information server 102 may be, or may be a part of, a media hub or gateway that monitors and/or distributes various types of media to media devices for consumption by users within a building (e.g., a home) or establishment. The types of media may include, for example, television programs, advertisements, websites, games, music, videos, communications, etc., that may be provided by one or more media service providers 122. The media and/or information regarding the media provided to various media devices in the home or establishment may be provided to the information server by one or more media service providers 122 via network 110 or 120. In an embodiment, a media item may be provided from a media service provider 122 to information server 102, and may be provided to the appropriate media device 112 by information server 102 via the appropriate network(s). In this embodiment, information server 102 may monitor the activity of a particular media device by monitoring the media items that pass through the information server 102. In another embodiment, a media item may be provided from a media service provider 122 directly to the appropriate media device 112 via the appropriate network that may not pass through information server 102. In this embodiment, the information server may obtain information regarding the media item being consumed by a particular media device by querying the particular media device itself

As will be described more fully below, information server 102 may be configured to provide targeted information (e.g., advertisements, media recommendations, etc.) to particular media devices 112 based on the locations of the media devices (e.g., what room they are in) and/or the media being consumed on those and other media devices in the same location (e.g., in the same room). In an embodiment, the information provided by the information server 102 may be obtained by the information server 102 from local data source 116, which may be a part of information server 102 or directly accessible by information server 102. The information in data source 116 may be updated periodically (e.g., by one or more media service providers 122, or by information server 102). In another embodiment, the information provided by information server 102 may be obtained by the information server 102 from external data source 118 via network 110 or 120 (as shown in FIG. 1). Data source 118 may be, for example, a data or advertisement server. In an example, information server 102 may update the information in data source 116 with information it obtains from data source 118. In another embodiment, information server 102 may request the information from one or more media service providers 122, which may, in turn, obtain the information from an external data source 118 before providing the information to information server 102.

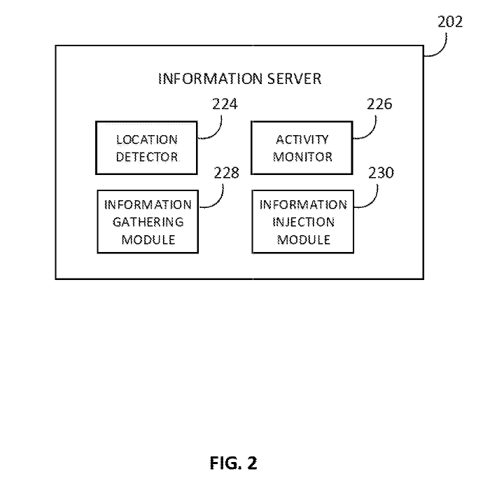

FIG. 2 is a block diagram of an example information server 202, according to an embodiment. Information server 202 may include a location detector 224, an. activity monitor 226, an information gathering module 228, and an information injection module 230.

Location detector 224 may determine the locations of media devices 112 using one or more of various location detection methods. For example, some media devices 112 (e.g., televisions, speakers, etc., that may be likely to remain in one place) may have had their locations pre-defined during a setup operation, where a user or administrator setting up the system may have entered a location or room for various devices. Similarly, for media devices that may be mobile, location training may have been previously conducted, where a user or administrator may carry a mobile media device from room to room, recording each room entered. In these or other examples, depending on the capability of each of the media devices 112, location detection methods may be used, such as, for example, but not to be limited to, IP address association, wireless radio technology, Wi-Fi technology, global positioning technology, Bluetooth® technology, and/or triangulation technology, as would be understood by those of ordinary skill in the art. One or more of these methods may also, or instead, be used for proximity detection or determination. For example, in an embodiment, a location of a media device 112 may be determined by determining its proximity to information server 102/202, which may have a fixed location. In another embodiment, a location of a media device 112 may be determined by determining its proximity to media devices 112 that have fixed known. locations, which may be accomplished even if the fixed media devices 112 are not turned on. From this, the closest fixed media device 112 may be determined, which may in turn determine the location of the media device 112 in question. Threshold distances may be used to more accurately determine whether a particular media device 112 is in the same room as a fixed media device 112. In an embodiment, location detector 224 may determine what room of a building or home a media device 112 is in, using a table or database lookup based on location information it obtains. For example, if location detector 224 determines that a particular media device 112 is within a predetermined proximity of a fixed media device 112, it may look up what room fixed media device 112 is in to determine what room the media device 112 in question is in. Location detector 224 may also use one or more of the above-described technologies to determine proximities of media devices 112 to each other, even if neither is at a fixed location. In embodiments, some media devices 112 may require software or applications to be loaded in order for their locations to be determined.

Activity monitor 226 may determine what a user is doing and/or viewing on one or more media devices 112. In an embodiment, activity monitor 226 may monitor activity of media: devices 112 as it comes through information server 102/202. In another embodiment, if a media. device 112 is accessing media that is not coming through information server 102/202 (e.g., via a telephone service provider on a smart phone), information server 102/202 may query that media device 112 to determine the activity taking place on it. The querying of a media device 112 may take place regularly or as needed. Activity monitor 226 may determine the activity occurring on a particular media device 112 by extracting key words (e.g., text or spoken/audio) and/or metadata from, or regarding, the data being presented on media device 112. From these key words or metadata, topics regarding the activity may be determined. In embodiments, some media devices 112 may require software or applications to be loaded in order or user activity to be determined.

Information gathering module 228 may obtain information categorically associated with the determined topics being consumed on a particular media device 112 and/or the determined location of the media device 112. For example, information gathering module 228 may use one or more algorithms to determine what types of information (types of advertisements, types of recommendations, etc.) may be appropriate for the user of the media device 112 based on the determined topics and/or the determined location (e.g., in a home, a kitchen, a living room, a family room, an adult's bedroom, a child's bedroom, etc.) of the media device 112. As there are many algorithms that may be used for this purpose, as would be understood by those of ordinary skill in the art, particular algorithms will not be discussed here. As topics may range from very broad to very detailed, information gathering module 228 may need to determine various alternate topics or categories of information that may need to be requested in addition to the already-determined topics. Information gathering module 228 may be limited in what topics or categories of information to request based on previously set constraints or preferences per particular media device 112, per user, and/or per location (e.g., per room in a house). For example, previously-designated constraints or preferences may have been defined by a user of the media device 112 or by an administrator of the information server. As an example, an administrator may set a constraint to prevent previews of R-rated media from being provided to media devices in a child's bedroom. As another example, a user who may be a sports fanatic may set preferences that all information provided be sports-related. In another example, preferences may be set to indicate a user, media device, or location (e.g., room) is not to receive targeted information (e.g., an opt-out preference).

Information gathering module 228 may, in various ways, request and/or otherwise obtain information that is appropriate in light of the determined topics or categories, location, and/or any preferences/constraints. In an embodiment, information gathering module 228 may search, or request a search of, a pre-loaded searchable local database for this information (e.g., data store 116 in FIG. 1). In other embodiments, information gathering module 228 may request this information from a media service provider 122 or from an internet accessible data or advertisement server (e.g., data source 118 in FIG. 1). In embodiments, the desired information may be streamed, batched, or periodically stored locally. In embodiments, information gathering module 228 may request, or search for, desired information of a specific delivery type, depending on in what activity environment the information is going to be presented. For example, if the information is going to be presented while a game is being played, it may be desirable for it to be in a banner-type presentation.

Once the desired information is obtained by the information gathering module 228, information injection module 230 may prepare it for presentation on the appropriate media device 112. For example, if the information includes one or more advertisements that are to be shown during presentation of a video or television program, information injection module 230 may queue the advertisement(s) for an upcoming commercial block. As another example, if the information includes a game or music recommendation to be delivered during the playing of a game, information injection module 230 may queue the recommendation as an upcoming banner to be displayed alongside of the game, or a window-type presentation to be displayed between level changes. Examples of presentations may include, but are not to be limited to, a window within a device screen, a banner across a device screen, a full device screen, an audio presentation through a speaker. etc. The presentations themselves may include, but are not to be limited to, still picture presentations, text presentations, video presentations, audio presentations, etc.

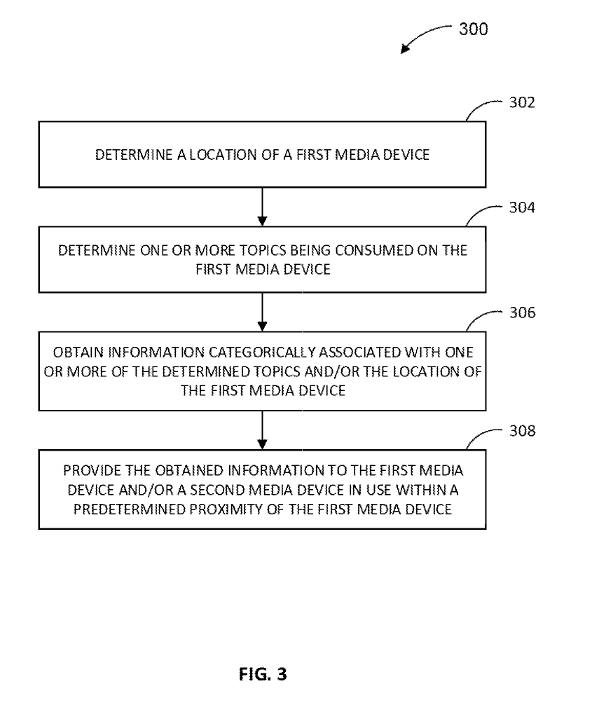

FIG. 3 is an example process flow 300 of providing targeted information by an information server to one or more media devices of a user located in a particular location, according to an embodiment. At 302, a location of a first media device may be determined. As an example, the information server may determine that a first media device (e.g., a smart phone) is currently being used in the kitchen of a home. At 304, one or more topics being consumed on the first media device may be determined. In furthering the example, the information server may determine that a recipe for barbecue sauce is being viewed on the smart phone. At 306, information categorically associated with one or more of the determined topics and/or the location of the first media device may be obtained. Continuing with the example, the information server may obtain information regarding barbecue sauce because a recipe for barbecue sauce is being viewed on the smart phone and the smart phone is located in the kitchen where cooking may take place, which may indicate topics or categories such as “cooking”, “recipe”, “barbecue sauce”, etc. At 308, the information server may provide the obtained information to the first media device and/or a second media device in use within a predetermined proximity of the first media device. In still furthering the example, the information server may provide an advertisement for barbecue sauce on the smart phone and/or a television that may also be on in the kitchen. In an embodiment, the time of day, day of the week, holiday status, etc., may also be a factor in determining what information is obtained and provided to a media device. In the kitchen example, if the media device is being used on a weekend afternoon, then information categorically associated with cleaning a pill, for example, may be obtained at 306 and provided at 308.

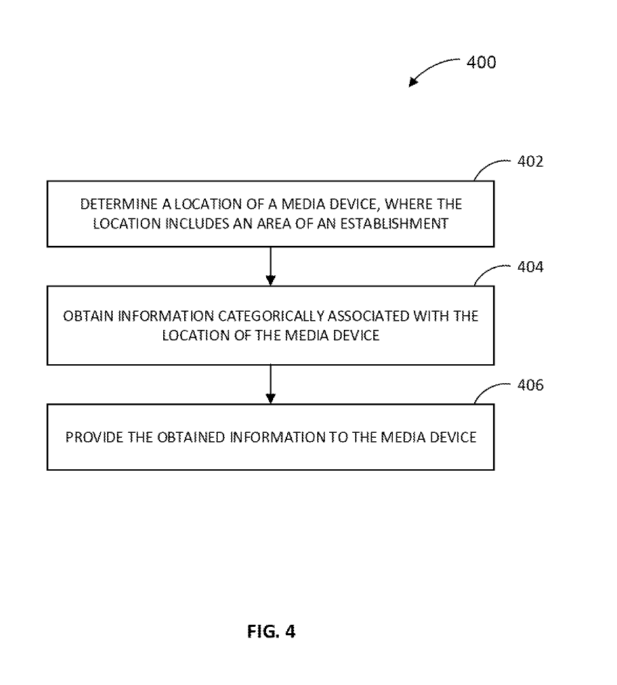

In an embodiment, information may be provided to a media device based solely on the location of the media device. FIG. 4 is an example process flow 400, illustrating this scenario. At 402, a location of a media device may be determined, where the location includes an area of an establishment. For example, an information server may determine that the media device is in a specific room or area of a hotel, office, home, or another type of establishment. At 404, information categorically associated with the location of the media device may be obtained. For example, if the information device determines that the media device is in a kitchen of a home, then information categorically associated with a kitchen (e.g., information associated with food, recipes, cooking, baking, cleaning, etc.) may be obtained. At 406, the obtained information may be provided to the media device. For example, an advertisement for tomato sauce may be provided to the media device. In an embodiment, the time of day, day of the week, holiday status, etc., may also be a factor in determining what information is obtained and provided to a media device. In the kitchen example, if the media device is being used in the morning, then information categorically associated with breakfast, for example, may be obtained at 404 and provided at 406.

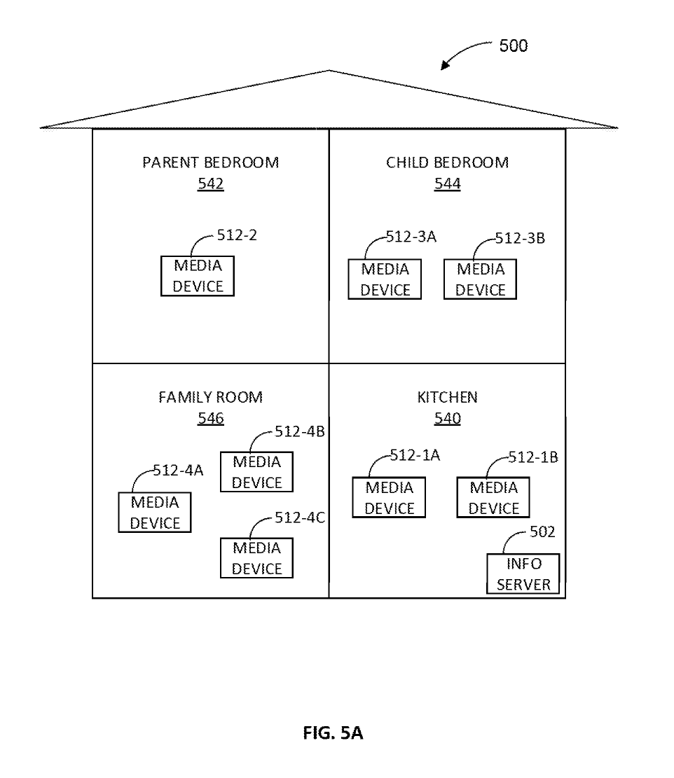

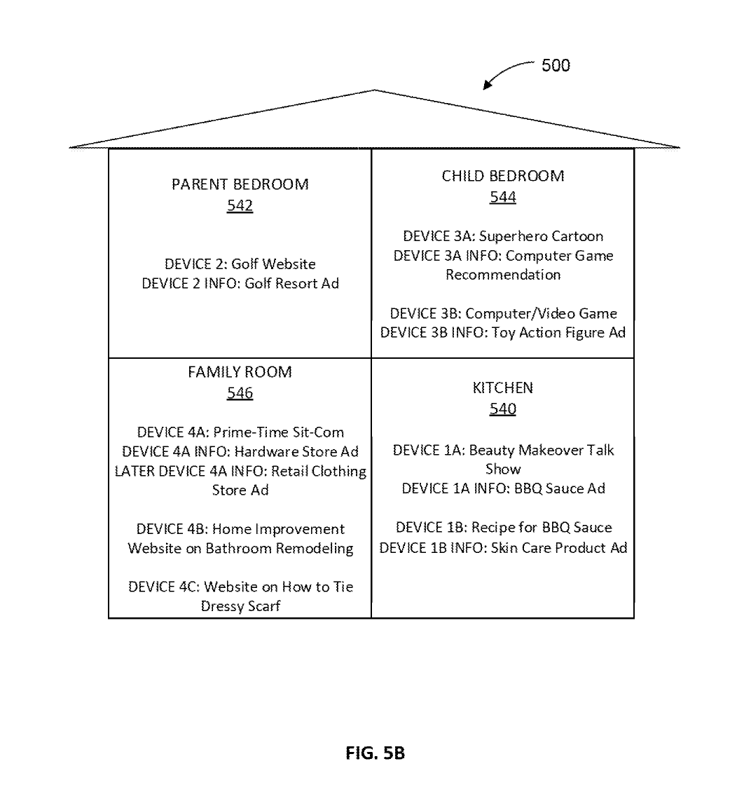

FIG. 5A is a block diagram illustrating an example room setup of a home 500, according to an embodiment. FIG. 5A will be discussed in conjunction with FIG. 5B, which is a block diagram illustrating media consumption examples of each device in various rooms of home 500, according to embodiments. These examples are examples of possible embodiments or scenarios that may occur in a home, including, or in addition to any scenarios previously discussed above. These examples are not exhaustive, however. There are many differing scenarios to which the concepts disclosed herein may apply, as would be understood by those of ordinary skill in the art.

Home 500 may include various rooms, such as, for example, a kitchen 540, a parent bedroom 542, a child bedroom 544, and a family room 546. In embodiments, any number of rooms or types of rooms may be included in home 500. Information server 502 may be located in the home. In home 500, information server 502 is shown as being in kitchen 540. In embodiments, information server 502 may be located anywhere in home 500. In some embodiments, information server 502 may be located outside home 500 (e.g., at a service provider headend). In some embodiments, portions of information server 502 may be located within home 500, while other portions of information server 502 may be located outside home 500.

Starting with an example in kitchen 540, information server 502 may determine that there are two media devices 512-1A and 512-1B in kitchen 540. For example, media device 512-1A may be a television presenting a beauty makeover talk show, and media device 512-1B may be a smart phone on which a recipe for barbecue sauce is being viewed. Information server 502 may determine (e.g., based on metadata, key words, etc.) the topics being accessed or discussed on each media device (e.g., “cooking”, “recipe”, “barbecue sauce”, etc., with regard to the recipe, and “beauty”, “skin care”, “hair care”, etc., with regard to the makeover show). Information server 502 may request and/or obtain information categorically associated with those topics and/or a “kitchen”, and may provide the information to one or more of the media devices. For example, information server 502 may deliver an advertisement for barbecue sauce to the television, and/or may deliver an advertisement for a skin care product to the smart phone.

Moving on to an example in parent bedroom 542, information server 502 may determine that there is one media device 512-2 located in parent bedroom 542. For example, media device 512-2 may be a tablet device on which a golf website is being viewed. In this example, no other device is being used in parent bedroom 542. Information server 502 may determine (e.g., based on metadata, key words, etc.) the topics being accessed or discussed on the media device (e.g., “sports”, “golf”, “golf equipment”, etc., with regard to the golf website). Information server 502 may request and/or obtain information categorically associated with those topics and/or a “bedroom of an adult”, and may provide the information to the media device. For example, information server 502 may deliver an advertisement for a golf resort to the tablet.

For child bedroom 544, information server 502 may determine that there are two media devices 512-3A and 512-3B being used in child bedroom 544. For example, media device 512-3A may be a tablet device on which a superhero cartoon is being played, and media device 512-3B may be a gaming system (e.g., a gaming system connected to a television) on which an action computer/video game is being played. Information server 502 may determine (e.g., based on metadata, key words, etc.) the topics being accessed or discussed on each media device (e.g., “cartoon”, “superhero”, “child video”, etc., with regard to the superhero cartoon, and “game”, “battle”, “fantasy”, etc., with regard to the game being played). Information server 502 may request and/or obtain information categorically associated with those topics and/or a “bedroom of a child”, and may provide the information to one or more of the media devices. For example, information server 502 may deliver an advertisement for a toy superhero action figure to the device on which the game is being played, and/or may deliver a recommendation for a game to the tablet device.

Moving to family room 546, information server 502 may determine that there are three media devices 512-4A, 512-4B, and 512-4C in family room 546. For example, media device 512-4A may be a television presenting a prime-time situation comedy, media device 512-4B may be a tablet device on which a home improvement website on bathroom remodeling is being viewed, and media device 512-4C may be a smart phone on which a web page on how to tie a.

dressy scarf is being viewed. Information server 502 may determine (e.g., based on metadata, key words, etc.) the topics being accessed or discussed on each media device (e.g., “prime-time”, “comedy”, “television show”, etc., with regard to the television show; “home improvement”, “remodel”, “bathroom”, etc., with regard to the remodeling website; and “clothing”, “accessories”, “scarf”, etc., with regard to the scarf-tying web page). Information server 502 may request and/or obtain information categorically associated with those topics and/or a “family room”, and may provide the information to one or more of the media devices. For example, information server 502 may deliver to the television an advertisement for a hardware store, and later may deliver to the television an advertisement for a retail clothing store. The information server 502 may also, or instead, deliver a recommendation for another situation comedy to one or more of the media devices (not shown in FIG. 5B).

There are other additional useful features that may be incorporated into a system such as the system described herein. For example, profiles may be set up for each user, media device, and/or location. A system administrator may be given the capability of providing settings in such profiles, as discussed earlier herein. However, in embodiments, it may be desirable to set up personal accounts for users of media devices to manage their own preferences for receiving targeted information. In these embodiments, it may be desirable for the system to know exactly who is using which media devices. This may be done automatically (e.g., via various known recognition techniques), manually (e.g., via a username and password), or a combination.

Another useful feature that may be incorporated may be the keeping of a record of historical use data or patterns, including, for example, the activities of each user and/or device, and/or in what location a device is used. The record may further keep track of when those activities occurred, or when the device was in various locations, including for example the time of day, day of the week, weekend versus weekday, holiday, etc. For example, if a media device is being used at 4 pm on a Sunday in the family room, sports-related information may be provided. A historical use record may further provide data that may help broaden the topics or categories of information that may be appropriate to provide to the media devices. Keeping a record of what information is provided may also be useful in deciding what information to provide subsequently (e.g., if no information is found that is relevant to a user's usage or location, then historical data May be used to identify other types of information that may interest the user, as a backup). In addition, how a consumer responds to the provided information may also be useful to record. As an example, if a consumer may respond to provided information or advertisements by clicking on them for more information, this may provide the system with useful information on which types of information or advertisements are the most effective or generate the most interest for a particular consumer, which may further be useful in deciding what information to provide at a later time.

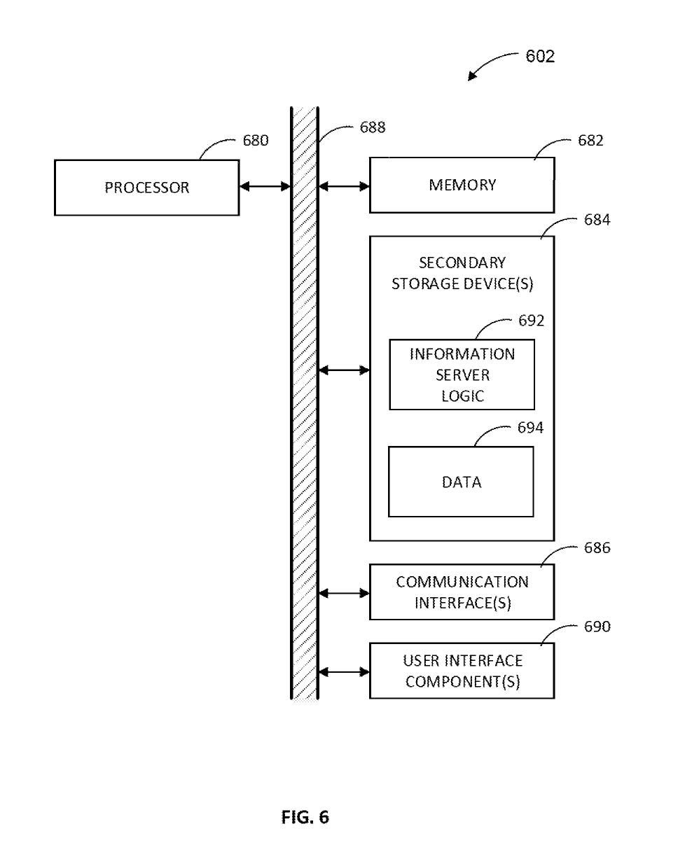

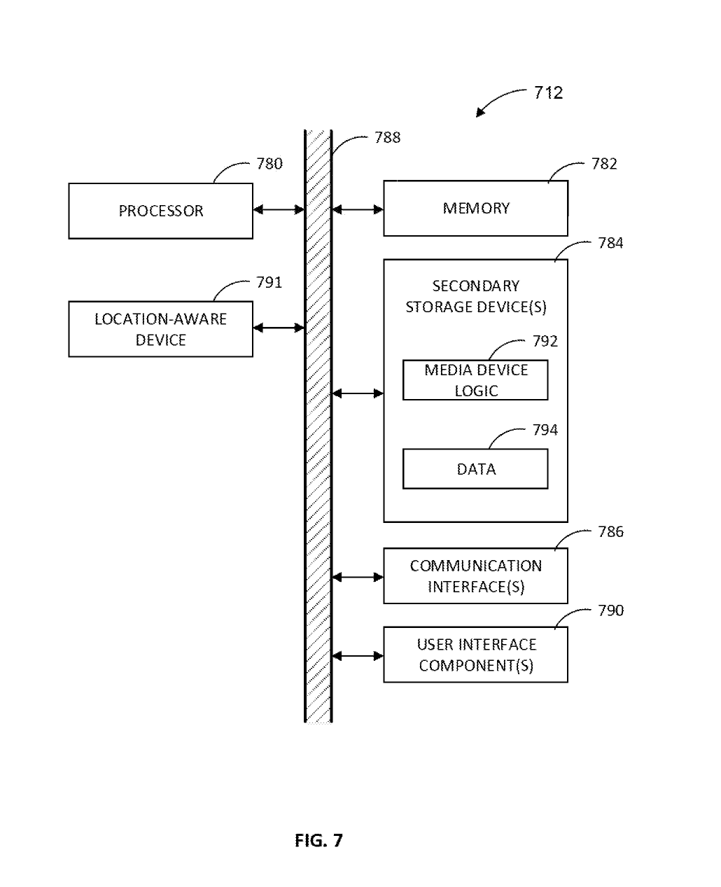

FIG. 6 is a block diagram of an example information server 602, according to an embodiment. The information server 602 may represent, for example, the information servers 102, 202, and 502 of FIGS. 1, 2, and 5A, respectively. As illustrated, information server 602 may include a processor or controller 680 connected to memory 682, one or more secondary storage devices 684, and a communication interface 686 by a link 688 or similar mechanism. The information server 602 may optionally include user interface components 690 for use by a system or service administrator, for example, that may include, for example, a touchscreen, a display, one or more user input components (e.g., a keyboard, a mouse, etc.), a speaker, or the like, or any combination thereof. Note, however, that while not shown, information server 602 may include additional components. The processor 680 may be a microprocessor, digital ASIC, FPGA, or similar hardware device. In an embodiment, the processor 680 may be a microprocessor, and software may be stored or loaded into the memory 682 for execution by the processor 680 to provide the functions described herein. The one or more secondary storage devices 684 may be, for example, one or more hard drives or the like, and may store logic 692 to be executed by the processor 680. The one or more secondary storage devices 684 may also, or instead, store data 694. Data 694 may include, for example, information that may be provided to one or more various media devices in communication with the information server 602, category associations and/or alternatives for the information, location information regarding the one or more various media devices, etc. The communication interface 686 may be implemented in hardware or a combination of hardware and software. The communication interface 686 may provide a wired or wireless network interface to a network, such as network 110 and/or network 120 shown in FIG. 1. FIG. 7 is a block diagram of an example media device 712, according to an embodiment.

The media device 712 may represent, for example, any of the media devices shown in FIGS. 1 and 5A. As illustrated, media device 712 may include a processor or controller 780 connected to memory 782, one or more secondary storage devices 784, and a communication interface 786 by a link 788 or similar mechanism. The media device 712 may include user interface components 790 for use by a user of the media device 712 that may include, for example, a touchscreen, a display, one or more user input components (e.g., a keyboard, a mouse, etc.), a speaker, or the like, or any combination thereof Media device 712 may include a location-aware device 791, such as a global positioning system (GPS) device or other location-aware device. Note, however, that while not shown, media device 712 may include additional components. The processor 780 may be a microprocessor, digital AMC, FPGA, or similar hardware device. In an embodiment, the processor 780 may be a microprocessor, and software may be stored or loaded into the memory 782 for execution by the processor 780 to provide the functions described herein. The one or more secondary storage devices 784 may be, for example, one or more hard drives or the like, and may store logic 792 to be executed by the processor 780. The one or more secondary storage devices 784 may also, or instead, store data 794. Data 794 may include, for example, location information, data related to various media that is being consumed or has been consumed, information to be presented to the user, etc. The communication interface 786 may be implemented in hardware or a combination of hardware and software. The communication interface 786 may provide a wired or wireless network interface to a network, such as network 110 shown in FIG. 1.

Methods and systems are disclosed herein with the aid of functional building blocks illustrating functions, features, and relationships thereof. At least sonic of the boundaries of these functional building blocks have been arbitrarily defined herein for the convenience of the description. Alternate boundaries may be defined so long as the specified functions and relationships thereof are appropriately performed. While various embodiments are disclosed herein, it should be understood that they are presented as examples. The scope of the claims should not be limited by any of the example embodiments disclosed herein.

As discussed above, one or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The terms software and firmware, as used herein, refer to a computer program product including at least one computer readable medium having computer program logic, such as computer-executable instructions, stored therein to cause a computer system to perform one or more features and/or combinations of features disclosed herein. The computer readable medium may be transitory or non-transitory. An example of a transitory computer readable medium may be a digital signal transmitted over a radio frequency or over an electrical conductor, through a local or wide area network, or through a network such as the Internet. An example of a non-transitory computer readable medium may be a compact disk, a flash memory, SRAM, DRAM, a hard drive, a solid state drive, or other data storage device.

Technologies disclosed herein provide targeted information, such as advertisements. recommendations, etc., to be delivered to one or more media devices being used by a consumer based on the activities conducted by the consumer on one or more of the media devices and/or the location of the consumer at the time of the activities. In embodiments, the time of the activities may also be a factor in what information is provided. The particular examples and scenarios used in this document are for ease of understanding and are not to be limiting. Features described herein may be used in many other contexts and situations that may or may not involve a home environment. For example, as stated earlier herein, the concepts disclosed herein may extend to such environments as hotels or resorts, dormitories, office buildings, schools, college campuses, office complexes, parks, amusement parks, etc.

There are various advantages of using the technologies described herein. One advantage is that even if, for example, the same channel is being viewed in two different rooms, the information (e.g., advertisements) provided may be specific to the viewers. Another advantage, in embodiments in which the information server is located within a home, for example, privacy of the users is maintained with regard to programs or videos watched, interne activity, game activity, etc. Many other advantages may also be contemplated.

As used in this application and in the claims, a list of items joined by the term “one or more of” can mean any combination of the listed terms. For example, the phrases “one or more of A, B or C” and “one or more of A, B, and C” can mean A; B; C; A and B; A and C; B and C; or A, B and C.

The following examples pertain to further embodiments.

Example 1 may include a location-based information server through which media content is provided to one or more media devices in networked communication with the information server, the information server comprising: a location detector configured to determine a location of a first media device, wherein the location includes an area of an establishment; an activity monitor configured to determine one or more topics being consumed on the first media device;

an information gathering module configured to obtain information categorically associated with one or more of the determined topics or the location of the first media device; and an information injection module configured to provide the obtained information to one or more of the first media device or a second media device in use within a predetermined proximity of the first media device.

Example 2 may include the subject matter of Example 1, Wherein the location detector is configured to determine the location of the first media device by determining whether the first media device is within a predetermined proximity of one or more other media devices with fixed known locations.

Example 3 may include the subject matter of Example 2, wherein the location detector is further configured to identify in what type of room each of the one or more other media devices is located.

Example 4 may include the subject matter of Example 1, wherein the location detector is configured to determine the location of the first media device by determining proximity of the first media device to the information server.

Example 5 may include the subject matter of any one of Examples 1-4, wherein the location detector is configured to determine the location of the first media device via one or more of: interne protocol (IP) address association, wireless radio technology, Wi-Fi technology, global positioning technology, Bluetooth® technology, triangulation technology, user designation, or previously-conducted location training.

Example 6 may include the subject matter of any one of Examples 1-5, wherein the activity monitor is configured to determine the one or more topics being consumed on the first media device by analyzing one or more of metadata, key words, or audio words associated with content presented on the first media device.

Example 7 may include the subject matter of any one of Examples 1-6, wherein the information gathering module is further configured to obtain information within previously-designated constraints based on one or more of the particular first media device, a user of the first media device, or the location of the first media device.

Example 8 may include the subject matter of Example 7, wherein the previously-designated constraints are defined by one or more of the user of the first media device or an administrator of the information server.

Example 9 may include the subject matter of any one of Examples 1-8, wherein the information gathering module is further configured to obtain the information based on historical use data associated with the first media device and the location of the first media device.

Example 10 may include the subject matter of any one of Examples 1-9, wherein the information gathering module is further configured to obtain the information based on one or more of current time of day, day of week, or holiday status.

Example 11 may include the subject matter of any one of Examples 1-10, wherein the information gathering module is configured to obtain the information from one or more of an external service provider, one or more external data servers, or one or more local storage devices.

In Example 12, any one of Examples 1-11 may optionally include one or more storage devices, wherein the one or more storage devices are configured to store one or more of: categorized information for potential distribution to one or more media devices, location information regarding one or more media devices, category association information, or category alternative information.

Example 13 may include the subject matter of any one of Examples 1-12, wherein the information injection module is configured to provide the obtained information to the first media device or second media device via one or more of a window within a device screen, a banner across the device screen, a full device screen, or an audio speaker.

Example 14 may include the subject matter of any one of Examples 1-13, wherein the information injection module is configured to provide the obtained information as one or more of one or more still picture presentations, one or more text presentations, one or more video presentations, or one or more audio presentations.

Example 15 may include the subject matter of any one of Examples 1-14, wherein the provided information comprises one or more of advertisements or media recommendations.

Example 16 may include the subject matter of any one of Examples 1-15, wherein the information gathering module is configured to obtain information categorically associated only with the determined topics.

Example 17 may include the subject matter of any one of Examples 1-15, wherein the information gathering module is configured to obtain information categorically associated only with the location of the first media device,

Example 18 may include the subject matter of any one of Examples 1-17, wherein the information injection module is configured to provide the obtained information to only the second media device.

Example 19 may include an apparatus for distributing information in a networked media system, comprising: means for determining a location of a first media device, wherein the location includes an area of an establishment; means for determining one or more topics being consumed on the first media device; means fir obtaining information categorically associated with one or more of the determined topics or the location of the first media device; and means for providing the obtained information to one or more of the first media device or a second media device in use within a predetermined proximity of the first media device.

Example 20 may include the subject matter of Example 19, wherein the means for determining the location of the first media device includes means for determining whether the first media device is within a predetermined proximity of one or more other media devices with fixed known locations.

Example 21 may include the subject matter of Example 20, wherein the means for determining the location of the first media device includes means for identifying in what type of room each of the one or more other media devices is located.

Example 22 may include the subject matter of Example 19, wherein the means for determining the location of the first media device includes means for determining the first media device's proximity to the apparatus.

Example 23 may include the subject matter of any one of Examples 19-22, wherein the means for determining the location of the first media device includes means for determining the location of the first media device via one or more of: internet protocol (IP) address association, wireless radio technology, Wi-Fi technology, global positioning technology, Bluetooth® technology, triangulation technology, user designation, or previously-conducted location training.

Example 24 may include the subject matter of any one of Examples 19-23, wherein the means for determining the one or more topics being consumed on the first media device includes means for analyzing one or more of metadata, key words, or audio words associated with content presented on the first media device.

Example 25 may include the subject matter of any one of Examples 19-24, wherein the means for obtaining information includes means for obtaining the information within previously-designated constraints based on one or more of the particular first media device, a user of the first media device, or the location of the first media device.

Example 26 may include the subject matter of Example 25, wherein the previously-designated constraints are previously defined by one or more of the user of the first media device or an administrator of the apparatus.

Example 27 may include the subject matter of any one of Examples 19-26, wherein the means for obtaining information includes means for obtaining the information based on historical use data associated with the first media device and the location of the first media device.

Example 28 may include the subject matter of any one of Examples 19-27, wherein the means for obtaining information includes means for obtaining the information based on one or more of current time of day, clay of week, or holiday status.

Example 29 may include the subject matter of any one of Examples 19-28, wherein the means for obtaining information includes means for obtaining the information from one or more of an external service provider, one or more external data servers, or one or more local storage devices.

In Example 30, the subject matter of any one of Examples 19-29 may optionally include means for storing one or more of: categorized information for potential distribution to one or more media devices, location information regarding one or more media devices, category association information, or category alternative information.

Example 31 may include the subject matter of any one of Examples 19-30, wherein the means for providing the obtained information includes means for providing the obtained information to the first media device or second media device via one or more of: a window within a device screen, a banner across the device screen, a full device screen, or an audio speaker.

Example 32 may include the subject matter of any one of Examples 19-31, wherein the means for providing the obtained information includes means for providing the obtained information as one or more of one or more still picture presentations. one or more text presentations, one or more video presentations, or one or more audio presentations.

Example 33 may include the subject matter of any one of Examples 19-32, wherein the provided information comprises one or more of advertisements or media recommendations.

Example 34 may include the subject matter of any one of Examples 19-33, wherein the obtained information is categorically associated only with the determined topics.

Example 35 may include the subject matter of any one of Examples 19-33, wherein the obtained information is categorically associated only with the location of the first media device.

Example 36 may include the subject matter of any one of Examples 19-35, wherein the means for providing the obtained information includes means for providing the obtained information to only the second media device.

Example 37 may include a computer-readable medium storing control logic configured to instruct a processor of an information server to: determine a location of a first media device, wherein the location includes an area of an establishment; determine one or more topics being consumed on the first media device; obtain information categorically associated with one or more of the determined topics or the location of the first media device; and provide the obtained information to one or more of the first media device or a second media device in use within a predetermined proximity of the first media device.

Example 38 may include the subject matter of Example 37, wherein the determining the location of the first media device includes determining whether the first media device is within a predetermined proximity of one or more other media devices with fixed known locations.

Example 39 may include the subject matter of Example 38, wherein the determining the location of the first media device includes identifying in what type of room each of the one or more other media devices is located.

Example 40 may include the subject matter of Example 37, the determining the location of the first media device includes determining the first media device's proximity to the information server.

Example 41 may include the subject matter of any one of Examples 37-40, wherein the determining the location of the first media device includes determining the location of the first media device via one or more of: internet protocol (IP) address association, wireless radio technology, Wi-Fi technology, global positioning technology, Bluetooth® technology, triangulation technology, user designation, or previously-conducted location training.

Example 42 may include the subject matter of any one of Examples 37-41, wherein the determining the one or more topics being consumed on the first media device includes analyzing one or more of metadata, key words, or audio words associated with content presented on the first media device.

Example 43 may include the subject matter of any one of Examples 37-42, wherein the obtaining information includes obtaining the information within previously-designated constraints based on one or more of the particular first media device, a user of the first media device, or the location of the first media device.

Example 44 may include the subject matter of Example 43, wherein the previously-designated constraints are previously defined by one or more of the user of the first media. device or an administrator of the information server.

Example 45 may include the subject matter of any one of Examples 37-44, wherein the obtaining information includes obtaining the information based on historical use data associated with the first media device and the location of the first media device.

Example 46 may include the subject matter of any one of Examples 37-45, wherein the obtaining information includes obtaining the information based on current time of day, day of week, or holiday status.

Example 47 may include the subject matter of any one of Examples 37-0, wherein the obtaining information includes obtaining the information from one or more of an external service provider, one or more external data servers, or one or more local storage devices.

Example 48 may include the subject matter of any one of Examples 37-47, wherein the control logic is further configured to instruct the processor to maintain a local storage device for storing one or more of: categorized information for potential distribution to one or more media. devices, location information regarding one or more media devices, category association information, or category alternative information.

Example 49 may include the subject matter of any one of Examples 37-48, wherein the providing the obtained information includes providing the obtained information to the first media device or second media device via one or more of: a window within a device screen, a banner across the device screen, a full device screen, or an audio speaker.

Example 50 may include the subject matter of any one of Examples 37-49, wherein the providing the obtained information includes providing the obtained information as one or more of: one or more still picture presentations, one or more text presentations, one or more video presentations, or one or more audio presentations.

Example 51 may include the subject matter of any one of Examples 37-50, wherein the provided information comprises one or more of advertisements or media recommendations.

Example 52 may include the subject matter of any one of Examples 37-51, wherein the obtained information is categorically associated only with the determined topics.

Example 53 may include the subject matter of any one of Examples 37-51, wherein the obtained information is categorically associated only with the location of the first media device.

Example 54 may include the subject matter of any one of Examples 37-53, wherein the obtained information is provided to only the second media device.

Example 55 may include a method of distributing information in a networked media system, comprising: determining, by an information server, a location of a first media device, wherein the location includes an area of an establishment; determining, by the information server, one or more topics being consumed on the first media device; obtaining, by the information server, information categorically associated with one or more of the determined topics or the location of the first media device; and providing, by the information server, the obtained information to one or more of the first media device or a second media device in use within a predetermined proximity of the first media device.

Example 56 may include the subject matter of Example 55, wherein the determining the location of the first media device includes determining whether the first media device is within a predetermined proximity of one or more other media devices with fixed known locations.

Example 57 may include the subject matter of Example 56, wherein the determining the location of the first media device includes identifying in what type of room each of the one or more other media devices is located.

Example 58 may include the subject matter of Example 55, wherein the determining the location of the first media device includes determining the first media device's proximity to the information server.

Example 59 may include the subject matter of any one of Examples 55-58, wherein the determining the location of the first media device includes determining the location of the first media device via one or inure of: internet protocol (IP) address association, wireless radio technology, Wi-Fi technology, global positioning technology, Bluetooth® technology, triangulation technology, user designation, or previously-conducted location training.

Example 60 may include the subject matter of any one of Examples 55-59, wherein the determining the one or more topics being consumed on the first media device includes analyzing one or more of metadata, key words, or audio words associated with content presented on the first media device.

Example 61 may include the subject matter of any one of Examples 55-60, wherein the obtaining information includes obtaining the information within previously-designated constraints based on one or more of the particular first media device, a user of the first media device, or the location of the first media device.

Example 62 may include the subject matter of Example 61, wherein the previously-designated constraints are previously defined by one or more of the user of the first media device or an administrator of the information server.

Example 63 may include the subject matter of any one of Examples 55-62, wherein the obtaining information includes obtaining the information based on historical use data associated. with the first media device and the location of the first media device.

Example 64 may include the subject matter of any one of Examples 55-63, wherein the obtaining information includes obtaining the information based on current time of day, day of week, or holiday status.

Example 65 may include the subject matter of any one of Examples 55-64, wherein the obtaining information includes obtaining the information from one or more of an external service provider, one or more external data servers, or one or inure local storage devices.

In Example 66, any one of Examples 55-66 may optionally include maintaining a local storage device for storing one or more of: categorized information for potential distribution to one or more media devices, location information regarding one or more media devices, category association information, or category alternative information.

Example 67 may include the subject matter of any one of Examples 55-66, wherein the providing the obtained information includes providing the obtained information to the first media. device or second media device via one or more of a window within a device screen, a banner across the device screen, a full device screen, or an audio speaker.

Example 68 may include the subject matter of any one of Examples 55-67, wherein the providing the obtained information includes providing the obtained information as one or more of one or more still picture presentations, one or more text presentations, one or more video presentations, or one or more audio presentations.

Example 69 may include the subject matter of any one of Examples 55-68, wherein the provided information comprises one or more of advertisements or media recommendations.

Example 70 may include the subject matter of any one of Examples 55-69, wherein the obtained information is categorically associated only with the determined topics.

Example 71 may include the subject matter of any one of Examples 55-69, wherein the obtained information is categorically associated only with the location of the first media device.

Example 72 may include the subject matter of any one of Examples 55-71, wherein the obtained information is provided to only the second media device.

Example 73 may include at least one machine readable medium comprising a plurality of instructions that in response to being executed on a computing device, cause the computing device to carry out a method according to any one of Examples 55-72.

Example 74 may include an apparatus configured to perform the method of any one of Examples 55-72.

Example 75 may include a computer system to perform the method of any one of Examples 55-72.

Example 76 may include a machine to perform the method of any one of Examples 55-72.

Example 77 may include an apparatus comprising means for performing the method of any one of Examples 55-72.

Example 78 may include a computing device comprising memory and a chipset configured to perform the method of any one of Examples 55-72.

Example 79 may include a location-based information server through Which media content is provided to one or more media devices in networked communication with the information server, the information server comprising: a location detector configured to determine a location of a media device, wherein the location includes an area of an establishment: an information gathering module configured to obtain information categorically associated with the location of the media device; and an information injection module configured. to provide the obtained information to the media device.

Example 80 may include the subject matter of Example 79, wherein the information gathering module is further configured to obtain the information based on historical use data associated with the media device and the location of the media device.

Example 81 may include the subject matter of Example 79 or Example 80, wherein the information gathering module is further configured to obtain the information based on current time of day, day of week, or holiday status.

Example 82 may include the subject matter of any one of Examples 79-81, wherein the establishment includes one or more of a house, a hotel, an office building, a dormitory, a school, a campus, a resort, an office complex, a park, or an amusement park.

Example 83 may include the subject matter of any one of Examples 79-82, wherein the area includes a room.

Example 84 may include an apparatus for distributing information in a networked media. system, comprising: means for determining a location of a media device, wherein the location includes an area of an establishment; means for obtaining information categorically associated with the location of the media device; and means for providing the obtained information to the media device.

Example 85 may include the subject matter of Example 84, wherein the means for obtaining information includes means for obtaining the information based on historical use data associated with the media device and the location of the media device.

Example 86 may include the subject matter of Example 84 or Example 85, wherein the means for obtaining information includes means for obtaining the information based on current time of day, day of week, or holiday status.

Example 87 may include a computer-readable medium storing control logic configured to instruct a processor of an information server to: determine a location of a media device, wherein the location includes an area of an establishment; obtain information categorically associated with the location of the media device; and provide the obtained information to the media device.

Example 88 may include the subject matter of Example 87, wherein the obtaining information includes obtaining the information based on historical use data associated With the media device and the location of the media device.

Example 89 may include the subject matter of Example 87 or Example 88, wherein the obtaining information includes obtaining the information based on current time of day, day of week, or holiday status.

Example 90 may include a method of distributing information in a networked media system, comprising: determining, by an information server, a location of a media device, wherein the location includes an area of an establishment; obtaining, by the information server. information categorically associated with the location of the media device; and providing, by the information server, the obtained information to the media device.

Example 91 may include the subject matter of Example 90, wherein the obtaining information includes obtaining the information based on historical use data associated with the media device and the location of the media device.

Example 92 may include the subject matter of Example 90 or Example 91, wherein the obtaining information includes obtaining the information based on current time of day, day of week, or holiday status.

Example 93 may include at least one machine readable medium comprising a plurality of instructions that in response to being executed on a computing device, cause the computing device to carry out a method according to any one of Examples 90-92.

Example 94 may include an apparatus configured to perform the method of any one of Examples 90-92.

Example 95 may include a computer system to perform the method of any one of Examples 90-92.

Example 96 may include a machine to perform the method of any one of Examples 90-92.

Example 97 may include an apparatus comprising means for performing the method of any one of Examples 90-92.

Example 98 may include a computing device comprising memory and a chipset configured to perform the method of any one of Examples 90-92.

1-25. (canceled)

26. A location-based information server through which media content is provided to one or more media devices in networked communication with the information server, the information server comprising:
a location detector configured to determine a location of a first media device, wherein the location includes an area of an establishment;
an activity monitor configured to determine one or more topics being consumed on the first media device;
an information gathering module configured to obtain information categorically associated with one or more of the determined topics or the location of the first media device; and
an information injection module configured to provide the obtained information to one or more of the first media device or a second media device in use within a predetermined proximity of the first media device.

27. The information server of claim 26, wherein the location detector is configured to determine the location of the first media device by determining whether the first media device is within a predetermined proximity of one or more other media devices with fixed known locations.

28. The information server of claim 27, wherein the location detector is further configured to identify in what type of room each of the one or more other media devices is located.

29. The information server of claim 26, wherein the location detector is configured to determine the location of the first media device by determining proximity of the first media device to the information server.

30. The information server of claim 26, wherein the location detector is configured to determine the location of the first media device via one or more of: internet protocol (IP) address association, wireless radio technology, Wi-Fi technology, global positioning technology, Bluetooth® technology, triangulation technology, user designation, or previously-conducted location training

31. The information server of claim 26, wherein the activity monitor is configured to determine the one or more topics being consumed on the first media device by analyzing one or more of metadata, key words, or audio words associated with content presented on the first media device.

32. The information server of claim 26, wherein the information gathering module is further configured to obtain information within previously-designated constraints based on one or more of the particular first media device, a user of the first media device, or the location of the first media device.

33. The information server of claim 32, wherein the previously-designated constraints are defined by one or more of the user of the first media device or an administrator of the information server.

34. The information server of claim 26, wherein the information gathering module is further configured to obtain the information based on historical use data associated with the first media device and the location of the first media device.

35. The information server of claim 26, wherein the information gathering module is further configured to obtain the information based on one or more of current time of day, day of week, or holiday status.

36. The information server of claim 26, wherein the information gathering module is configured to obtain the information from one or more of an external service provider, one or more external data servers, or one or more local storage devices.

37. The information server of claim 26, further comprising one or more storage devices, wherein the one or more storage devices are configured to store one or more of: categorized information for potential distribution to one or more media devices, location information regarding one or more media devices, category association information, or category alternative information.

38. The information server of claim 26, wherein the information injection module is configured to provide the obtained information to the first media device or second media device via one or more of: a window within a device screen, a banner across the device screen, a full device screen, or an audio speaker.

39. The information server of claim 26, wherein the information injection module is configured to provide the obtained information as one or more of one or more still picture presentations, one or more text presentations, one or more video presentations, or one or more audio presentations.

40. The information server of claim 26, wherein the provided information comprises one or more of advertisements or media recommendations.

41. The information server of claim 26, wherein the information gathering module is configured to obtain information categorically associated only with the determined topics.

42. The information server of claim 26, wherein the information gathering module is configured to obtain information categorically associated only with the location of the first media device.

43. The information server of claim 26, wherein the information injection module is configured to provide the obtained information to only the second media device.

44. An apparatus for distributing information in a networked media system, comprising:
means for determining a location of a first media device, wherein the location includes an area of an establishment;
means for determining one or more topics being consumed on the first media device;
means for obtaining information categorically associated with one or more of the determined topics or the location of the first media device; and
means for providing the obtained information to one or more of the first media device or a second media device in use within a predetermined proximity of the first media device.

45. A non-transitory computer-readable medium storing control logic configured to instruct a processor of an information server to:
determine a location of a first media device, wherein the location includes an area of an establishment;
determine one or more topics being consumed on the first media device;
obtain information categorically associated with one or more of the determined topics or the location of the first media device; and
provide the obtained information to one or more of the first media device or a second media device in use within a predetermined proximity of the first media device.

46. A method of distributing information in a networked media system, comprising:
determining, by an information server, a location of a first media device, wherein the location includes an area of an establishment;
determining, by the information server, one or more topics being consumed on the first media device;
obtaining, by the information server, information categorically associated with one or more of the determined topics or the location of the first media device; and
providing, by the information server, the obtained information to one or more of the first media device or a second media device in use within a predetermined proximity of the first media device.

47. The method of claim 46, wherein the determining the location of the first media device includes determining whether the first media device is within a predetermined proximity of one or more other media devices with fixed known locations.

48. The method of claim 47, wherein the determining the location of the first media device includes identifying in what type of room each of the one or more other media devices is located.

49. The method of claim 46, wherein the determining the location of the first media device includes determining the first media device's proximity to the information server.

50. The method of claim 46, wherein the obtaining information includes obtaining the information within previously-designated constraints based on one or more of the particular first media device, a user of the first media device, or the location of the first media device.
